(19) United States
(12) Patent Application Publication
(10) Pub. No.: US 2012/0163965 A1
(43) Pub. Date: Jun. 28, 2012

(54) Axial Compressor

(75) Inventors: Yasuo TAKAHASHI, Mito (JP); Chihiro Myoren, Tokai (JP); Ryou Akiyama, Hitachinaka (JP)

(73) Assignee: Hitachi, Ltd., Tokyo (JP)

(21) Appl. No.: 13/336,644

(22) Filed: Dec. 23, 2011

(30) Foreign Application Priority Data
Dec. 28, 2010 (JP) 2010-291544

(51) Int. Cl. F01D 9/04; B23P 6/00; B23P 15/00

(52) U.S. Cl. 415/199.4; 29/888.025; 29/888.021

(57) ABSTRACT

When a gas turbine is operated with inlet guide vanes (IGVs) closed during part load operation or the like, the degradation of aerodynamic performance and of reliability may potentially occur since the load on rear stage side vanes of a compressor increases. An object of the present invention is to suppress the degradation of the aerodynamic performance and of reliability of an axial compressor.

The axial compressor includes a rotor; a plurality of rotor blade rows installed on the rotor; a casing located outside of the rotor blade rows; a plurality of stator vane rows installed on the casing; and exit guide vanes installed on the downstream side of a final stage stator vane row among the stator vane rows. An incidence angle of a flow toward the final stage stator vane row is equal to or below a limit line of an incidence operating range.

### BACKGROUND OF THE INVENTION

1. Field of the Invention

The present invention relates to an axial compressor.

2. Description of the Related Art

JP-2-223604-A is documents disclosing the background art of the present technical field. JP-2-223604-A relates to a stator vane capable of changing a setting angle, and discloses that front portion and rear portion of the stator vane are each slidably turned around an axial center to smoothly and continuously deform the camber angle of the stator vane.

### SUMMARY OF THE INVENTION

When a gas turbine is operated with inlet guide vanes (IGVs) closed during part load operation or the like, the degradation of aerodynamic performance and of reliability may potentially occur since the load on rear stage side blades/vanes of a compressor increases. An object of the present invention is to suppress the degradation of the aerodynamic performance and of reliability of an axial compressor.

According to an aspect of the present invention, there is provided an axial compressor including a rotor; a plurality of rotor blade rows installed on the rotor; a casing located on the outside of the rotor blade rows; a plurality of stator vane rows installed on the casing; and exit guide vanes installed on the downstream side of a final stage stator vane row among the stator vane rows; wherein an incidence angle of a flow toward the final stage stator vane row is equal to or below a limit line of an incidence operating range.

The present invention can provide an axial compressor that is allowed to suppress the degradation of aerodynamic performance and of reliability.

### BRIEF DESCRIPTION OF THE DRAWINGS

FIG. 1 is a graph showing an incidence operating range for ambient temperature in an embodiment of the present invention.

FIG. 2 is a system configuration diagram of a gas turbine according to the embodiment of the present invention.

FIG. 3 is an axial cross-sectional view of an axial compressor according to the embodiment of the present invention.

FIG. 4 includes span-directional cross-sectional views of a final stage stator vane and a graph for an incidence angle-total pressure loss characteristic associated with the final stage stator vane.

FIG. 5 is a span-directional cross-sectional view of a final stage stator vane used in the embodiment of the present invention.

FIGS. 6A and 6B are span-directional cross-sectional views of a stator vane of the axial compressor.

FIG. 7 is a graph of isentropic Mach number distributions on the surfaces of a final stage stator vane used in the embodiment of the present invention.

FIGS. 8A and 8B show a shroud structure of the final stage stator vane used in the embodiment of the present invention.

FIG. 9 is a graph showing a stage pressure ratio encountered during the full load and part load operation of the axial compressor.

### DESCRIPTION OF THE PREFERRED EMBODIMENT

The present invention is described, taking an axial compressor for a gas turbine as an example. The present invention can be applied to axial compressors for industrial applications as well as for gas turbines.

An operation of a uniaxial gas turbine in which a turbine and a compressor are connected to each other through one shaft, includes one in which inlet guide vanes (IGVs) of the compressor are closed with the combustion temperature of the gas turbine kept at a rated condition in order to broaden the operating load range of the gas turbine. Such operation has a possibility that a load on the rear stage side blades/vanes of the compressor is increased to cause flow separation on blade surfaces. If the separation occurs, there is concern about the degradation of aerodynamic performance and of reliability. In particular, this event becomes conspicuous during the operation at extremely-low temperatures.

A two-shaft gas turbine in which a turbine is divided into a high pressure turbine and a low pressure turbine, which are configured to have respective different rotating shafts, needs such operation that IGVs are close more during part load operation as compared with that in an normal operation in order to achieve a balance between the output power of the high pressure turbine and the power of a compressor. Also such operation has concern that a load on the rear stage side blades/vanes of the compressor is increased to increase blade vibration due to the unsteady flow separation.

The axial compressors for the uniaxial type and two-shaft type gas turbines can share the basic specifications of blades/vanes, exclusive of a scale ratio. This makes the amount of time and work, which are required for the design, test, and production of blades/vanes, decrease significantly. To that end, while considering the operating conditions of the gas turbine, it is necessary to modify the design of an aerofoil profile to deal with an increase in the load on final stage stator vanes. Further, an inner extraction slit for cooling a turbine rotor is provided on the upstream side of the final stage stator vanes. When a large amount of compressed air is bled from the slit, the axial velocity on the inner circumferential side of the final stage stator vanes is reduced to make an inlet flow angle increase and thereby likely make the load on the vane increase further. Thus, it is important to consider operating conditions other than that at the rated point of the final stage stator vanes, such as part load operation and a variation in ambient temperature, in view of the aerodynamic performance and reliability of the overall compressor.

In short, even during the strictest operation of the gas turbine, if it can suppress the separation on the suction surface side of the rear stage stator vanes and thereby can avoid the increase in the vibration of the vanes, it can provide the axial compressor that can ensure improved efficiency and reliability. For this purpose, it is effective to set an incidence angle, which is a difference between an inlet flow angle of a flow toward each of the final stage stator vanes of the axial compressor and an inlet blade angle, to a level equal to or below the limit line of an incidence operating range.

In this way, even if a load on the stator vanes located on the rear stage side of the compressor is increased, in an operation in which the IGVs are closed, such as an operation of the uniaxial type gas turbine or the part load operation of the two-shaft type gas turbine, separation occurring on the suction surfaces of the final stage stator vanes can be suppressed and the reliability of the vanes can be ensured. In addition, although, because of the inner extraction slit for cooling the turbine rotor and for sealing provided on the upstream side of the final stage stator vanes, the axial velocity on the inner circumferential side of the final stage stator vanes is reduced to increase the inlet flow angle, the vane operation range can be broadened and the improved performance and reliability of the vanes can be ensured.

Further, the operating range of the rear stage side stator vanes of the compressor can be broadened, whereby a variation in the opening of the IGVs can be increased during the part load operation of the gas turbine. Because of this, the inlet flow rate for the compressor can be controlled. As a result, the operating range of the part load operation of the gas turbine can be broadened.

FIG. 2 is a schematic diagram of a gas turbine system. A configuration of the gas turbine system is hereinafter described by way of example with reference to FIG. 2.

The gas turbine system includes a compressor 1 for compressing air to produce high-pressure air, a combustor 2 for mixing the compressed air with fuel for combustion, and a turbine 3 rotatably driven by a high-temperature combustion gas. The compressor 1 and the turbine 3 are connected to a generator 4 via a rotating shaft 5. The gas turbine of the present embodiment is assumed to be of a uniaxial type. However, the gas turbine of the present embodiment may be a two-shaft gas turbine in which a high-pressure turbine and a low-pressure turbine on the turbine side are configured to have respective separate shafts.

A flow of working fluid is next described. Air 11 or working fluid flows into the compressor 1 and then flows as high-pressure air 12 into the combustor 2 while being compressed by the compressor. In the combustor 2, the high-pressure air 12 and fuel 13 are mixed and burnt to produce a combustion gas 14. The combustion gas 14 rotates the turbine 3 and then is discharged as exhaust gas 15 toward the outside of the system. The generator 4 is driven by the rotational power of the turbine transmitted through the rotating shaft 5 passing through the compressor 1 and the turbine 3. The high-pressure air is partially supplied as turbine rotor cooling air and sealing air from the rear stage of the compressor 1 via an inner circumferential side passage of the gas turbine to the turbine side. This air 16 is led to a high-temperature combustion gas passage of the turbine 3 while cooling the turbine rotor. This cooling air also plays a role of sealing air for suppressing the leakage of the high-temperature gas from the high-temperature combustion gas passage of the turbine into the inside of the turbine rotor.

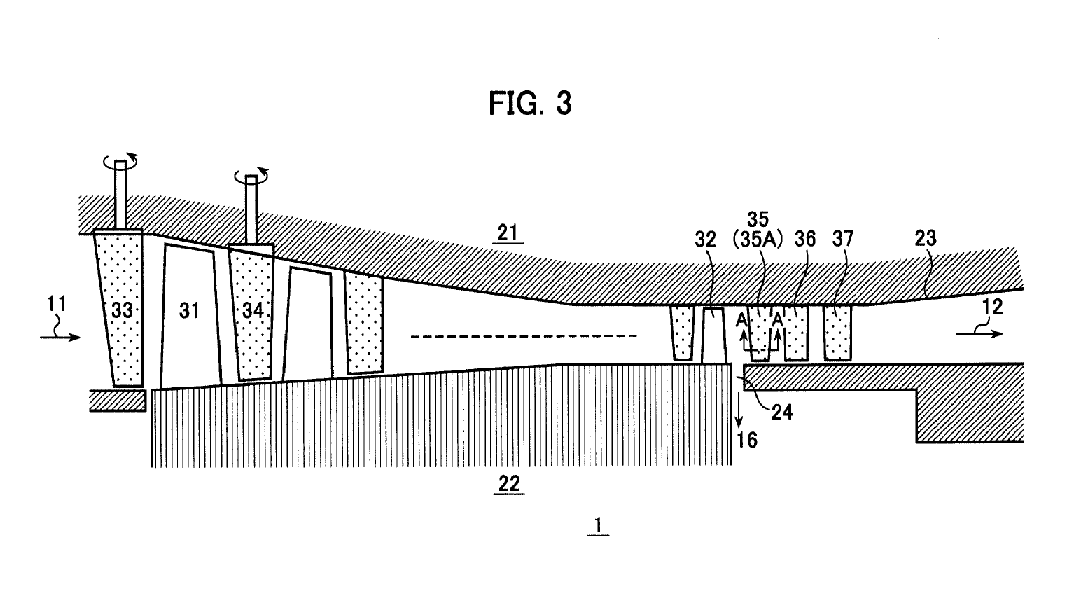

FIG. 3 is a schematic view of a multistage axial compressor. The axial compressor 1 is composed of a rotating rotor 22 on which plural rows of rotor blades 31 and a row of rotor blades 32 are mounted and a casing 21 on which plural rows of stator vanes 34 and a row of stator vanes 35 are mounted. The axial compressor 1 has an annular flow passage defined by the rotor 22 and the casing 21. The rotor blades 31 and 32 and the stator vanes 34 and 35 are arranged alternately in the axial direction. A single row of rotor blades and a single row of stator vanes constitute a stage. Inlet guide vanes (IGVs) 33 for controlling an inlet flow rate are installed on the upstream side of the initial stage rotor blade vanes 31.

Front stage side stator vanes of the compressor 1 of the present embodiment are provided with a variable mechanism for controlling rotating stall occurring at the time of the start of the gas turbine. FIG. 3 illustrates a case where variable stator vanes having the variable mechanism are provided in only one stage; however, the variable stator vanes may be provided in plural stages.

The final stage stator vanes 35 and exit guide vanes (EGV) 36, 37 are installed on the downstream side of the final stage rotor blades 32. The EGVs 36, 37 are installed in order to change almost all the absolute tangential velocity component of the working fluid, which applied to by the rotor blades in the annular flow passage, into the axial velocity component. In order to lead the flow from the EGV 37 to the combustor with decelerating, a diffuser 23 is installed on the downstream side of the compressor. Incidentally, although FIG. 3 illustrates a case where two stages of the EGVs are provided in the axial direction, the EGVs may be of a single row or more rows. An inner circumferential extraction slit 24 is provided on an inner circumference that is located on the downstream side of the final stage rotor blades 32 and on the upstream side of the final stage stator vanes 35 so as to supply the turbine rotor cooling air and sealing air 16.

The air 11 flowing into the annular flow passage is decelerated and compressed by the rotor blades and the stator vanes to become a high temperature high pressure air current, while passing through the annular flow passage of the compressor 1. Specifically, the fluid is increased in kinetic energy by the rotation of the rotor blades and reduced in velocity by the stator vanes so that the kinetic energy is converted into pressure energy to increase the pressure of the fluid. In this way, the rotor blades give absolute tangential velocity to the working fluid. Therefore, the flow of the working fluid toward each of the final stage stator vanes 35 of the compressor 1 moves thereinto at an inlet flow angle of approximately 50 to 60 degrees. It is necessary to set the high-pressure air 12, which is a flow moving into the diffuser 23 located at an exit of the compressor, to an inlet flow angle of zero degrees (an axial velocity component). To meet the necessity, it is important to change the direction of the flow from approximately 60 degrees to 0 degree by the final stage stator vanes 35 and the exit guide vanes 36, 37 for improving aerodynamic performance.

Incidentally, a pressure rise in each row of vanes (corresponding to a load on the vanes) is determined by the setting angle and operating state of the vanes. It is necessary to ensure the aerodynamic performance and reliability of the vanes even in the state where the load on the vanes is heaviest.

A description is next given of the operating state of the gas turbine compressor.

The gas turbine needs to ensure performance and reliability in dealing with not only a full load operation but also startup and a part load operation, and further a change in ambient temperature. The part load characteristic of the gas turbine is improved to enlarge the operating load range of the gas turbine. This has many advantages in terms of operation during a night time in which electric power is not needed so much.

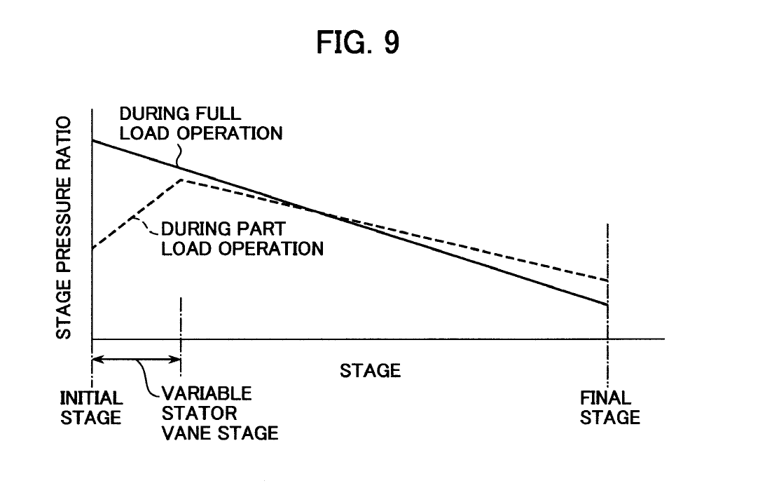

One of methods of controlling the output of a uniaxial gas turbine involves varying the inlet flow rate of the compressor by opening and closing the IGVs with a combustion temperature kept at a rated temperature in order to enlarge the operating range. If the IGVs are closed in such operation, there is concern about an increase in the load on the rear stage vanes of the compressor, particularly, on the final stator vanes 35. This reason is described below with reference to FIG. 9.

FIG. 9 shows stage pressure ratio distribution encountered during the full load operation of the axial compressor. In general, the stage pressure ratio distribution encountered during the full load operation of the axial compressor formulates substantial linear reduction from an initial stage to a final stage as indicated with a solid line in FIG. 9. On the other hand, stage pressure ratio distribution during part load operation in which the IGVs and the variable stator vanes are closed is shown with a dotted line in FIG. 9. During the part load operation, an inlet flow angle with respect to the rotor blade is small in the stage having the variable stator vane; therefore, a stage pressure ratio (a stage load) is reduced. The stage pressure ratio from the stage after the variable stator vane to the final stage reduces linearly. On the other hand, it is necessary for other stages to cover the reduced pressure at the variable stator vane. Therefore, the stage pressure ratio (the stage load) is inevitably higher than that during the full load operation as it goes toward the rear stage side.

When ambient temperature is low, a load on the rear blades/vanes is significantly increased during this part load operation. This degrades the reliability and aerodynamic performance of the blades and vanes. When the load on the blades/vanes reaches a limit line, the blades and vanes undergo fluid excitation due to separation. If the vibrational stress of the blade/vane reaches an allowable stress value or more, the blade/vane is increasingly likely to be damaged.

If plural stages of variable stator vanes are installed on the front stage side of the compressor, also the variable stator vanes are usually opened and closed in conjunction with the IGVs. Also the variable stator vanes are closed during the part load operation in which the IGVs are closed. Therefore, although the stage including the variable stator vanes is reduced in stage work, the pressure ratio of the overall compressor remains unchanged. Thus, this leads to a further increased load on the rear stage blades/vanes. Further, since a sidewall boundary layer grows on the rear stage side of the annular flow passage, axial velocity lowers at a sidewall portion. Due to the influence of the lowering axial velocity, an inlet flow angle is increased at the sidewall portion of the stator vane, so that a load is increased at the sidewall portion as compared with that at a main stream portion. Thus, a flow is likely to separate more at the sidewall portion of the rear stage side blade/vane than that at front stage side blade/vane.

On the other hand, during part load operation in the two-shaft gas turbine, in order to keep a balance between the output of the high pressure turbine and the power of the compressor, the IGVs are closed to reduce an inlet flow rate, thereby reducing the power of the compressor. However, the high pressure turbine needs to increase a pressure ratio to increase the output. In such operation where the IGVs and the variable stator vanes are closed, a load on the rear stage side blades/vanes, particularly, on the final stage stator vanes is increased. Thus, there arises a problem about ensuring performance and reliability.

The increased load on the rear stator vanes is largely influenced also by ambient temperatures. If ambient temperature decreases, the above-mentioned characteristics of the compressor become conspicuous, so that a possibility of degrading the reliability of the gas turbine during part load operation becomes high. Likewise, also a gas turbine system in which a quantity of water is sprayed at an inlet of a compressor to improve the output power and efficiency of a gas turbine has a tendency to reduce a load on the front stage side blades/vanes of the compressor and increase a load on the rear stage side blades/vanes. This poses the same problem as that in the above-mentioned operation.

The extraction slit 24 adapted to bleed turbine rotor cooling air and sealing air is provided on an inner circumference that is located on the upstream side of the final stage stator vanes in the present embodiment. When a quantity of bleed air is extracted through the extraction slit, an inlet flow angle of the flow moving into each of the final stage stator vanes is increased. If the inner extraction is performed on the upstream side of the final stage stator vanes, axial velocity reduces on the inner circumferential side of the stator vanes due to the extraction. Therefore, there is a possibility that an inlet flow angle is increased so that a flow stalls on the suction surface generate significant separation. As for a cantilever stator vane mounted to a casing, such as the final stage stator vane 35 in FIG. 3, if separation occurs particularly on the inner circumferential side, the stator vane undergoes fluid excitation and is likely to be damaged by fluid vibrations such as buffeting or stall flutter.

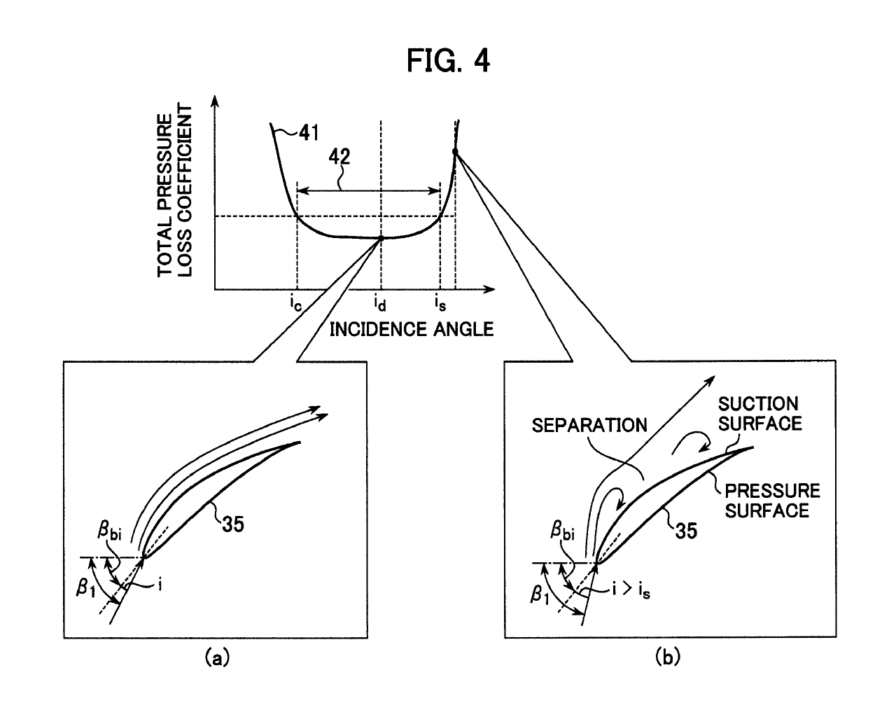

A problem about an increased load on the final stage stator vane 35 is described with reference to FIG. 4. FIG. 4 includes span-directional cross-sectional views of the final stator vane 35 and a graph for an incidence angle-total pressure loss characteristic. Incidentally, an incidence angle is represented by a difference between an inlet flow angle β₁ of a flow moving toward a vane and an inlet blade angle β_{b1}.

The final stage stator vane 35 is designed so that vane performance may be maximum at an incidence angle i_{d} during the rated operation of the gas turbine and an operating range 42 from a choke side i_{c} to a stall side iₛ can sufficiently be ensured in various operating ranges such as between starting operation and rated operation. A flow moving toward the stator vane 35 at the incidence angle i_{d} is decelerated along the suction surface side and led to the exit guide vanes 36 on the downstream side. However, during the part load operation of the gas turbine, if the incidence angle of the final stage stator vane 35 is increased and changed above the stall side limit incidence angle iₛ due to low ambient temperatures, an increased amount of inner extraction and further an increased pressure ratio, separation occurs on the suction surface side of the stator vane 35, which leads to the positive stall of the vane. Such a separation phenomenon has a negative effect on the performance and reliability of the vane. Therefore, it is necessary to enlarge the operating range 42 of the stator vane 35 in order to suppress the separation on the vane surface. In view of this, it is important to achieve an appropriate incidence angle of the stator vane 35.

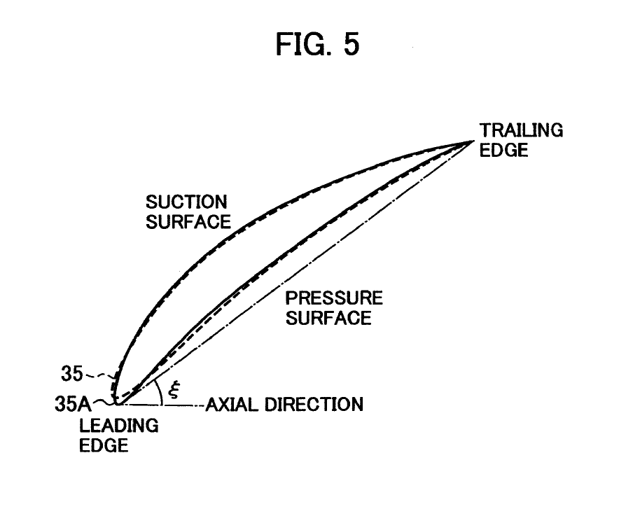

A method of improving the incidence angle of the final stage stator vane 35 of the present embodiment is described with reference to FIG. 5. FIG. 5 is a cross-sectional view of the final stage stator vane taken along line A-A in FIG. 3. In FIG. 5, a dotted line denotes a stator vane 35 or a comparative vane and a solid line denotes a modified stator vane 35A of the present embodiment. A row of the stator vanes 35 are circumferentially mounted to the casing at a certain pitch length and similarly a row of the improved stator vanes 35A are circumferentially mounted to the casing at a certain pitch length. FIG. 5 shows only a single vane in a circumferential direction and in span-directional cross-section and omits the other vanes.

As for the modified stator vane 35A of the present embodiment, the camber angle at the trailing edge of the vane is not changed while the camber angle in the vicinity of the leading edge of the vane is increased (a curvature radius is reduced). Consequently, a setting angle which is an angle between a vane-chord direction and an axial direction, is greater than that in the comparative vane 35. Incidentally, “the vicinity of the leading edge of the vane” means an area on the leading edge side relative to a position corresponding to the maximum thickness part of the vane. Specifically, the position corresponding to the maximum thickness part of the modified stator vane 35A of the present embodiment corresponds to a 30-40% chord length. In this way, the camber angle on an upstream side and a leading edge side of the position corresponding to the maximum thickness part of the modified stator vane 35A or the final stage stator vane is changed bigger than the camber angle on a downstream side of the position, the amount of change is bigger in comparison with the comparative vane 35 as a reference vane (i.e. a general aerofoil profile called the NACA 65 as described below). This can enlarge the operating range that is to the stall side incidence angle iₛ. On the other hand, the flow moving toward the downstream exit guide vane does not change; therefore, the influence of the flow on the exit guide vanes can be minimized.

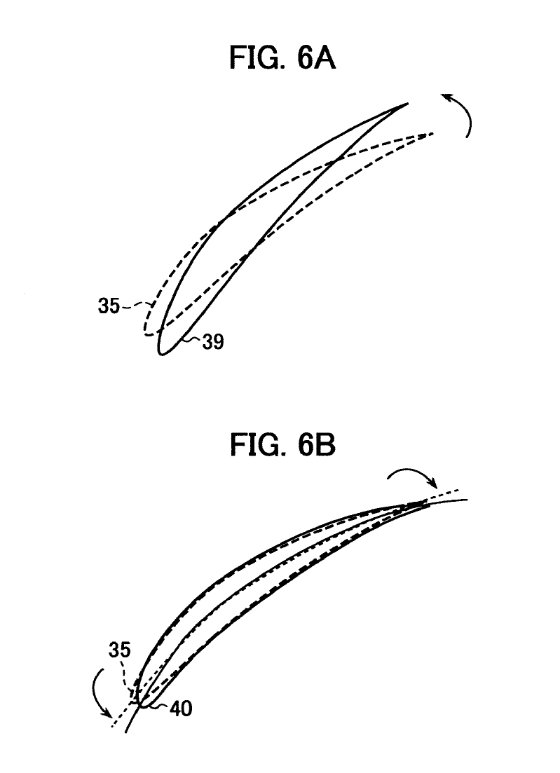

A general method of improving an incidence angle is described with reference to FIGS. 6A and 6B. FIGS. 6A and 6B are span-directional cross-sectional views of the stator vane of the axial compressor 1. To improve an incidence angle, a method of changing the setting angle of a vane (from a vane 35 to a vane 39 as shown FIG. 6A) or a method of changing the camber angle of an overall vane (from a vane 35 to a vane 40 as shown FIG. 6B) is generally adopted. Such improvement can produce an effect of broadening an operating range that is to the stall side incidence angle iₛ, similarly to the vane 35A of the present embodiment shown in FIG. 5. However, the outlet flow angle of the final stator vane 39 or 40 deviates from that of the comparative vane 35; therefore, an inlet flow angle with respect to the exit guide vane 36 located on the downstream side thereof is varied. In particular, the method shown in FIG. 6A increases the outlet flow angle of the stator vane 39. Therefore, the inlet flow angle of the exit guide vane 36 is increased so that a flow is likely to separate on the suction surface side of the exit guide vane 36. This leads to the degradation of the performance and reliability of the compressor.

A description is given of the reason that the methods shown in FIGS. 6A and 6B are common practice. If only a setting angle ξ is changed without modifying an aerofoil profile as shown in FIG. 6A, there is an advantage that the drawing of the aerofoil profile can be omitted. The usual drawing of an aerofoil profile is made with a setting angle set to zero degree. Therefore, if only the setting angle is changed, the drawing of the aerofoil profile can be shared.

A general aerofoil profile called the NACA 65 aerofoil is applied to the rear stage blades/vanes. This aerofoil design method creates an aerofoil profile by adding a thickness distribution to a camber line. Such an aerofoil design method has also prepared design tools; therefore, it can substantially automatically design an aerofoil profile if such a profile is as shown in FIG. 6B in which only a camber line is modified and the thickness distribution is not modified.

When the aerofoil profile is modified as shown in FIGS. 6A and 6B, such a design method is applied to a plurality of the stator vane rows among the corresponding rotor blade rows. This application makes it possible to modify the design so that a flow (an outlet flow angle) from the trailing edge of the modified final vane may fall within an allowable range. However, as described earlier, it is desirable that the exit guide vane located on the downstream side of the final stator vane be allowed to have an outlet flow angle of zero. In addition, the aerofoil profile can be modified in only a stator vane among the vane and blade and also the number of vane stages is small. The use of these findings leads to a conclusion that the designing method of the present embodiment is effective. The modifications of the aerofoil profiles as shown in FIGS. 6A and 6b result in the increased misalignment of the outlet flow angle, which degrades performance and reliability. The use of the modified stator vane 35A as in the present embodiment can suppress the misalignment of the outlet flow angle.

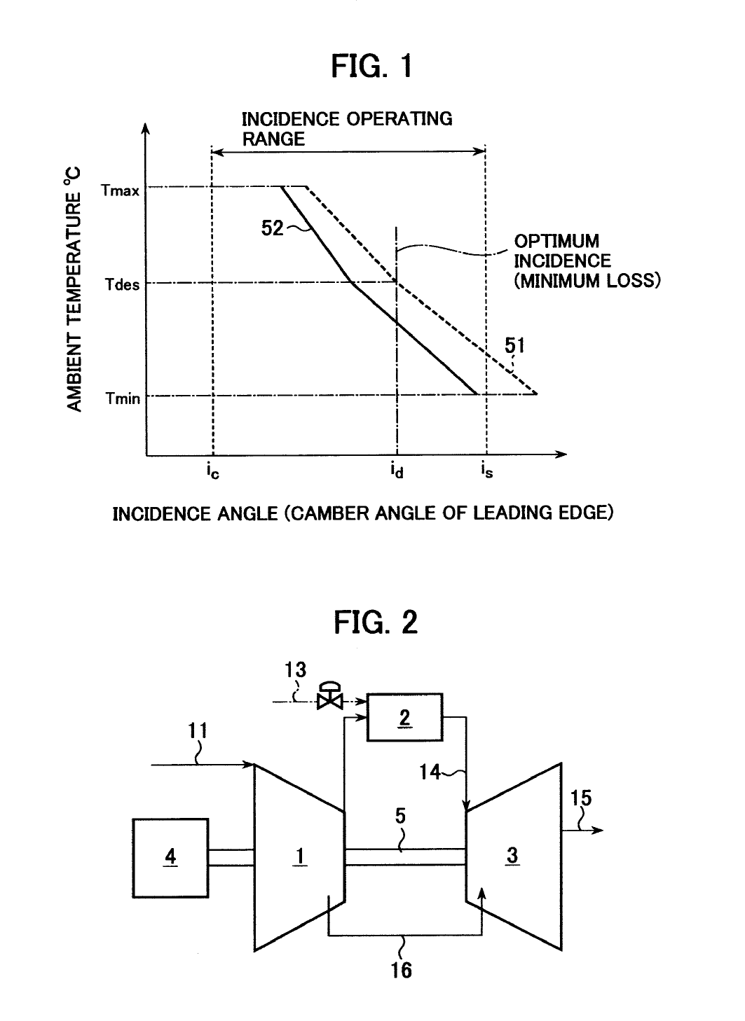

An amount of camber in the vicinity of the leading edge of the modified stator vane 35A in the present embodiment is next described with reference to FIG. 1. FIG. 1 shows the relationship between an incidence angle and ambient temperature. The incidence angle corresponds to the camber angle of the leading edge.

While considering a part load and ambient temperature characteristics, a vane is designed at a design incidence angle i_{d} where a loss is minimized at design ambient temperature Tdes. However, considering a difference in operating control between a uniaxial gas turbine and a two-shaft gas turbine and operating conditions such as a part load and extremely-low ambient temperature, an incidence operating range may be tighten. If the vane of the compressor can be shared even in such an operating range of the gas turbine, there are great advantages in design, production, assembly, management, etc.

A dotted line 51 of FIG. 1 shows a case in which a comparative vane is designed to minimize a loss at the design ambient temperature Tdes and the incidence angle exceeds a stall side limit line iₛ at an ambient temperature Tmin during part load operation. In such a operating condition, the incidence angle is equal to or larger than a maximum value of the incidence operating range. Thus, a flow separates (positive stall) on the suction surface side as shown in FIG. 4B, which increases the probability of an increased loss and vane damage that is due to fluid vibration.

The modified stator vane 35A of the present embodiment is designed to have an increased camber in the vicinity of the leading edge as indicated with a solid line in FIG. 5. Therefore, the incidence angle at the ambient temperature Tmin is designed to be less than the stall limit incidence iₛ as indicated with the solid line 52. In this way, the incidence angle at the design ambient temperature Tdes deviates from the incidence angle i_{d} where the loss is minimized. Thus, the loss is slightly increased. However, the incidence angle on the high-temperature side Tmax has a sufficient allowance with respect to the choke side limit incidence i_{c}. By allowing the tolerance of the stall side incidence angle to take precedence, separation (negative stall) on the choke side, i.e., on the pressure side does not have risk of causing vane vibration even if the incidence angle exceeds the choke limit incidence i_{c}. Thus, the modified stator vane 35A of the present embodiment can ensure reliability.

As described above, the incidence angle at low temperatures (for example, −10° C. close to the minimum temperature in Tokyo or −40° C. close to the minimum temperature in Japan) is set to a level lower than the stall limit incidence. In this way, the incidence angle is allowed to fall within the incidence operating range in the full temperature range. This minimizes a loss at the design ambient temperature. Thus, even during the part load operation at the low temperatures, the reliability of the final stage stator vane can be ensured.

That is to say, there is provided the axial compressor including: a rotor or the rotating shaft 5; the plurality of rotor blade rows mounted on the rotor; the casing 21 located outside of the rotor blade rows; the plurality of stator vane rows mounted on the casing 21; and the exit guide vanes 36, 37 installed on the downstream side of the final stage stator vane row 35A among the stator vane rows, wherein the incidence angle of the flow toward the final stage stator vane row 35A is equal to or below the limit line of the incidence operating range. Therefore, since the separation of the flow on the suction surface can be suppressed, the axial compressor can be provided that is not likely to increase a loss and damage the vanes/blades due to fluid vibration and that is allowed to suppress the degradation of aerodynamic performance and of reliability.

Incidentally, since the axial compressor has the inner extraction slit on the upstream side of the final stage stator vane row, it produces a further large effect of suppressing the degradation of the aerodynamic performance and of reliability. This is because the axial velocity on the inner circumferential side of the final stage stator vane row is reduced to increase the inlet flow angle, whereby a load applied to the vanes is particularly large.

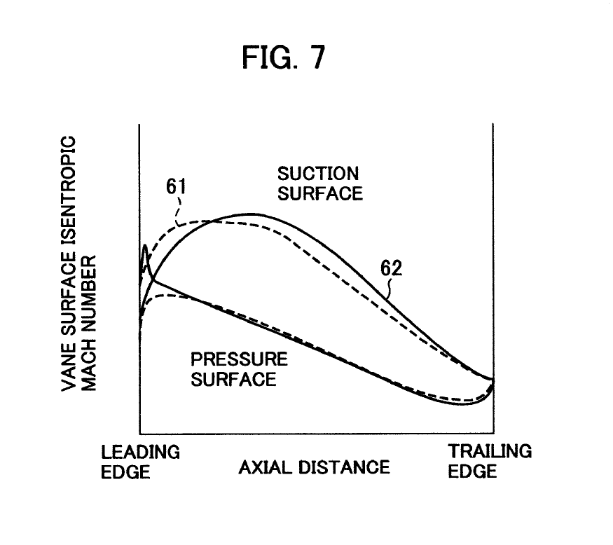

FIG. 7 shows a comparison of isentropic Mach number distribution on vane surfaces. Dotted lines 61 denote Mach number distribution on a comparative vane at the design ambient temperature Tdes and solid lines 62 denote Mach number distribution on the modified stator vane 35A of the present embodiment. A side showing, as a whole, higher Mach numbers represents the suction surface and a side showing lower Mach numbers represents the pressure surface.

One of the differences of the modified stator vane 35A from the comparative vane shown in FIG. 7 is that the pressure surface side Mach number distribution intersects the suction surface side Mach number distribution at a position close to the leading edge of the vane. As for both of the modified stator vane 35A and comparative vane, as the incidence angle is increased, the Mach number at a position close to the leading edge on the suction surface is higher and a difference in Mach number at a position close to the leading edge is increased between the suction surface and the pressure surface. If the incidence angle exceeds the limit value of the Mach number at a position close to the leading edge on the suction surface, separation occurs on the suction surface. The Mach number on the suction surface at a position close to the leading edge of the comparative vane is higher than that of the pressure surface and the Mach number distribution is broadened. Therefore, as the incidence angle is increased, the maximum Mach number at the leading edge is increased and the flow on the suction surface side is likely to separate. On the other hand, the modified stator vane 35A of the present embodiment is designed such that the Mach number on the suction surface is lowered at a position close to the leading edge until the Mach number distribution on the pressure surface intersects that on the suction surface at a position close to the leading edge. In this way, even if the incidence angle is increased, the modified stator vane 35A has a margin for the maximum Mach number at the leading edge as compared with the comparative vane. It is possible, therefore, to set the incidence angle to a level below the stall limit incidence even during the part load operation at the lowest temperature Tmin. Thus, the performance during the part load operation can be improved and reliability can be ensured.

The vane surface isentropic Mach number at a rated temperature is made up so that the Mach number distributions on the pressure surface side and on the suction surface side are interchanged with each other as described above. This can substantially enlarge the incidence operating range. Thus, the reliable axial compressor can be provided.

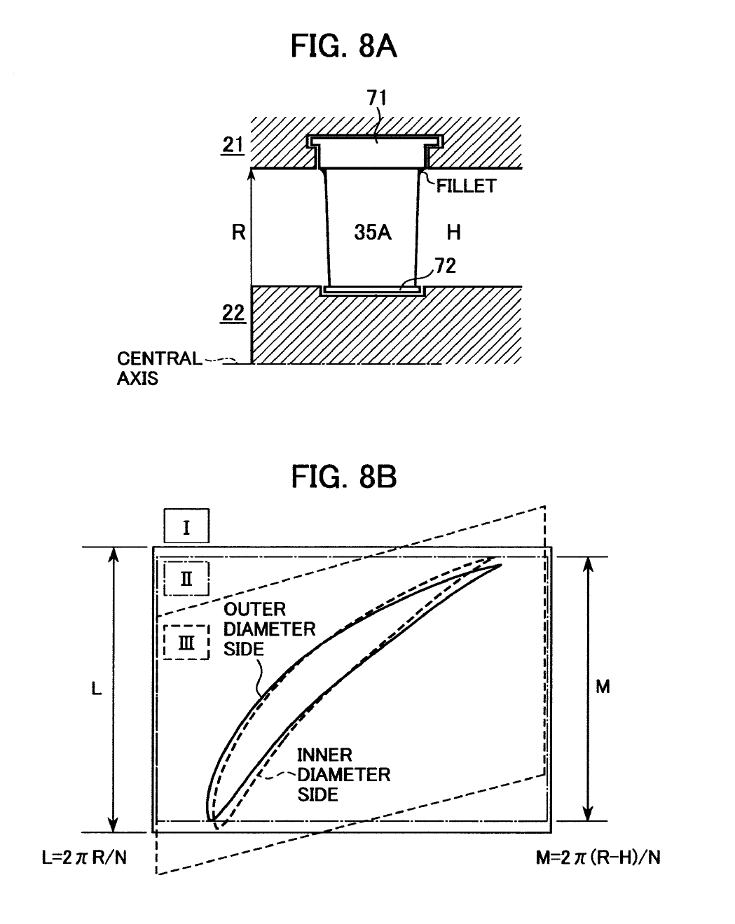

The modified stator vane 35A of the present embodiment configured to ensure reliability for fluid vibration is described with reference to FIGS. 8A and 8B. FIGS. 8A and 8B show a shroud configuration of the final stage stator vane. FIG. 8A shows a support structure of the final stage stator vane, in which a dove tail structure 71 and a shroud structure 72 are provided on the outer diameter side and on the inner diameter side, respectively, and the final stage stator vane is supported at both the ends thereof. As shown in FIG. 3, a general final stage stator vane is configured to be cantilevered on a casing side by a dove tail structure. On the other hand, the final stage stator vane of the present embodiment is supported at both the ends thereof, so that the rigidity of the vane can be increased to suppress the vibration of the vane due to fluid excitation.

Unlike the rotor blade, the rear stage side stator vanes usually have a uniform chord length from the inner diameter to outer diameter of the vane and also almost the same setting angle. Therefore, the shape of the vane is nearly linear in the vane-height direction. The blade/vane of the compressor is made of a rectangular parallelepipedic material by machining. Therefore, in view of a material cost, it is desirable that the dove tail shape be sized to be able to ensure the fillet radius of the vane.

A fillet is a term used in the field of welding and means a thickened-corner portion. As shown in FIG. 8A, the fillet is shaped such that the thickness of the vane potion is increased in a stepped manner toward a dove tail surface. The presence of the fillet reduces local stress acting on the root of the vane. In general, as the radius of the fillet is large, the local stress can be reduced more. However, if the radius of the fillet is increased, the dove tail portion is likely to be broken halfway from the dove tail. If the fillet portion is broken halfway, a step shaped along an annular gas path is formed at a dove tail contact surface of an adjacent vane. The formation of the step is undesirable because the influence of the step leads to the degradation of aerodynamic performance.

Further, the casing of a gas turbine compressor for industrial applications has a vertical half-split structure. Therefore, if the shape of a gas path surface of the dove tail has a rectangular structure, when a stator vane is inserted into the casing during assembly, the half-split surface of the casing and the dove tail lateral surface can be made coincident with each other. Thus, there is an advantage that assembly inspection can be facilitated.

Although the circumferential length M of the inner circumferential side shroud is shorter than the circumferential length L of the dove tail because of a difference between the radii of the vane, designing both the inner and outer circumferences of the vane to have a rectangular structure provides advantages in a material cost and assembly performance in view of manufacturing performance. However, when the compressor vane having a casing side cantilever structure may be modified into a double end supporting structure as in the present embodiment, considering the operation of the gas turbine, the following problem arises. If the shape of the shroud side gas path surface is made rectangular (II) as indicated with a chain line in FIG. 8B, it is difficult to ensure a fillet R of a vane. At the worst, also the respective vicinities of the leading and trailing edges of the vane may not ride on the shroud. In particular, the final stage stator vane has a large setting angle; therefore, also due to this respect, it is difficult to make the shroud structure rectangular (II).

Such a structure cannot ensure the rigidity in the respective vicinities of the leading and trailing edges of the vane. Therefore, this structure is less reliable than a structure in which the full surface of the vane is covered by the shroud. Since gaps locally occur at the tips of the vane, there is concern about an increased loss due to a leakage loss and a flow collision loss.

To eliminate such concern, the modified stator vane 35A of the present embodiment is connected to the dove tail and the shroud at both corresponding ends thereof. In addition, the outer circumferential side dove tail is designed to have the rectangular structure indicated with the solid line in FIG. 8B and the inner circumferential side shroud is designed to have a structure (III) in which the circumferential end faces indicated with the dotted lines in FIG. 8B are inclined. In other words, the circumferential end face of the dove tail is made different in inclination from that of the shroud. Specifically, the shape of the dove tail viewed in the radial direction is a rectangle and the shape of the shroud viewed in the radial direction is a parallelogram. The dove tail and the shroud are structured to have such shapes described above as to support both the respective outer and inner circumferential ends of the modified stator vane 35A. Therefore, the excitation of the vane due to fluid vibration of the vane can be suppressed even during part load operation at low temperatures. Thus, the reliability of the gas turbine can be ensured.

As described above, the performance and reliability of the gas turbine can be ensured by use of the compressor of the present embodiment. In addition, the gas turbine system that can enlarge the operating load range can be provided. By replacing a final stage stator vane (for a example, a general aerofoil profile called the NACA 65) of an existing compressor with the modified stator vane 35A of the present embodiment, i.e., by modifying the existing compressor, a compressor can be provided that produces the various effects described above in the present embodiment.

What is claimed is:

1. An axial compressor comprising:
a rotor;
a plurality of rotor blade rows installed on the rotor;
a casing located outside of the rotor blade rows;
a plurality of stator vane rows installed on the casing; and
exit guide vanes installed on a downstream side of a final stage stator vane row among the stator vane rows,
wherein an incidence angle of a flow toward the final stage stator vane row is equal to or below a limit line of an incidence operating range.

2. The axial compressor according to claim 1,
Wherein each stator vane of the final stage stator vane row is configured so that isentropic Mach number distributions at a rated temperature on a pressure surface side and on a suction surface side are reversed in magnitude relation at a portion close to a leading edge of the vane.

3. The axial compressor according to claim 1,
wherein each stator vane of the final stage stator vane row is connected to a dove tail and a shroud, and
a circumferential end face of the dove tail and a circumferential end face of the shroud are different in inclination from each other.

4. A method of designing the axial compressor according to claim 1,
Wherein the method comprise the step of:
designing each stator vane of the final stage stator vane row so that a camber angle on an upstream side and a leading edge side of a position corresponding to the maximum thickness part of the vane is changed bigger than a camber angle on a downstream side of the position, the amount of change being bigger in comparison with a stator vane as a reference.

5. A method of remodeling an axial compressor, the axial compressor including:
a rotor;
a plurality of rotor blade rows installed on the rotor;
a casing located outside of the rotor blade rows;
a plurality of stator vane rows installed on the casing; and
exit guide vanes installed on a downstream side of a final stage stator vane row among the stator vane rows,
Wherein the method comprise the step of:
replacing each stator vane of the final stage stator vane row with a modified stator vane, the modified stator vane being configured that a camber angle on an upstream side and a leading edge side of a position corresponding to the maximum thickness part of the vane is changed bigger than a camber angle on a downstream side of the position and the amount of change is bigger in comparison with the previous stator vane.

6. A compressor stator vane having a dove tail and a shroud,
wherein a circumferential end face of the dove tail and a circumferential end face of the shroud are different in inclination from each other.

7. The compressor vane according to claim 6,
wherein a shape of the dove tail viewed in a radial direction is a rectangle and a shape of the shroud viewed in the radial direction is a parallelogram.

8. The axial compressor according to claim 1, further comprising:
an inner extraction slit on an upstream side of the final stage stator vane row.

9. The axial compressor according to claim 1,
wherein the incidence angle of the flow toward the final stage stator vane row is equal to or below a limit line of an incidence operating range at an ambient temperature of −40° C.
